(19) United States
(12) Patent Application Publication
(10) Pub. No.: US 2012/0136693 A1
(43) Pub. Date: May 31, 2012

(54) SYSTEM AND METHOD FOR A PROCESS OVERVIEW DIAGRAM

(75) Inventors: Chatur B. Patil, Bangalore (IN); Prasanna C. M, Puliangudi (IN)

(73) Assignee: SAP AG, Walldorf (DE)

(21) Appl. No.: 12/956,758

(22) Filed: Nov. 30, 2010

(51) Int. Cl. G06Q 10/00; G06F 3/048

(52) U.S. Cl. 705/7.27; 715/777

(57) ABSTRACT

Embodiments of the present invention may provide a method for process management. The method may comprise reading information about sub-processes and their respective sub-steps of a main process and displaying a process overview diagram for the main process. The process overview diagram may display a tab for each sub-process and sub-step respectively. Each tab may include an icon indicating the status of a respective sub-process or sub-step. The tab for each sub-step may be displayed underneath and linked to the respective sub-process. The method may further comprise, responsive to a click to select a view level, expanding the tabs for sub-steps to show the person responsible for the respective sub-step, detailed contact information of the responsible person, a description of what needs to be performed and a link to send a quick reminder to the responsible person when the status for the respective sub-step is “in process”.

### FIELD

The disclosed subject matter relates to the field of computer systems and, more particularly, to a system and method for providing a process management and overview diagram.

### BACKGROUND

Modern companies and government agencies have been using software applications to manage various processes and projects. Typically, a complex process have multiple sub-processes and sub-steps within each sub-process. In most cases, the sub-processes or sub-steps run parallelly and are handled by different people or different organizations.

The existing software applications have a lot of limitations, however. For example, for a lengthy process with many steps, the existing software applications often do not provide a clear picture of what is the exact status of the overall process, or what are the exact statuses of the sub-processes/sub-steps. Further, most of the existing software applications do not provide information such as, number of sub-processes or sub-steps contained in the overall process, who is the person/department responsible for each step, or what precise actions the responsible person needs to take. For a few software applications that provide information about person/department responsible, the information is usually very limited and lacks details (e.g., contact information), and there is no facilities to help communicate with the responsible personnel directly through the software applications.

Accordingly, a need exists for a method and system for a process management and overview diagram that provides a clear picture of a complex process. The overview diagram should present all sub-process such that an end user can clearly identify the current status and the necessary action to be taken. Additionally the details of the person responsible for each action need to be provided, and in case any sub-step is in process there should be a facility to send a short e-mail reminder.

### BRIEF DESCRIPTION OF THE DRAWINGS

FIG. 1 illustrates an exemplary process overview diagram according to an embodiment.

FIG. 2 illustrates an exemplary process overview diagram according to an embodiment.

FIG. 3 illustrates another view of an exemplary process overview diagram according to an embodiment.

FIG. 4 illustrates a zoomed-in view of an exemplary process overview diagram according to an embodiment.

FIG. 5 illustrates another zoomed-in view of an exemplary process overview diagram according to an embodiment.

FIG. 6 illustrates another zoomed-in view of an exemplary process overview diagram according to an embodiment.

FIG. 7 illustrates an exemplary process overview diagram of an exemplary separation process according to an embodiment.

FIG. 8 shows a structure of a computer providing an exemplary process overview diagram according to an exemplary embodiment of the present invention.

FIG. 9 depicts a block diagram of an exemplary system according to one embodiment of the invention.

### DETAILED DESCRIPTION

Embodiments of the present invention may provide a method for process management. The method may comprise reading information about sub-processes and their respective sub-steps of a main process and displaying a process overview diagram for the main process. The process overview diagram may display a tab for each sub-process and sub-step respectively. Each tab may include an icon indicating the status of the respective sub-process or sub-step. The tab for each sub-step may be displayed underneath and linked to the respective sub-process. The method may further comprise, responsive to a click to select a view level, expanding the tabs for sub-steps to show the person responsible for the respective sub-step, detailed contact information of the responsible person, a description of what needs to be performed, and a link to send a quick reminder to the responsible person when the status for the respective sub-step is “in process”.

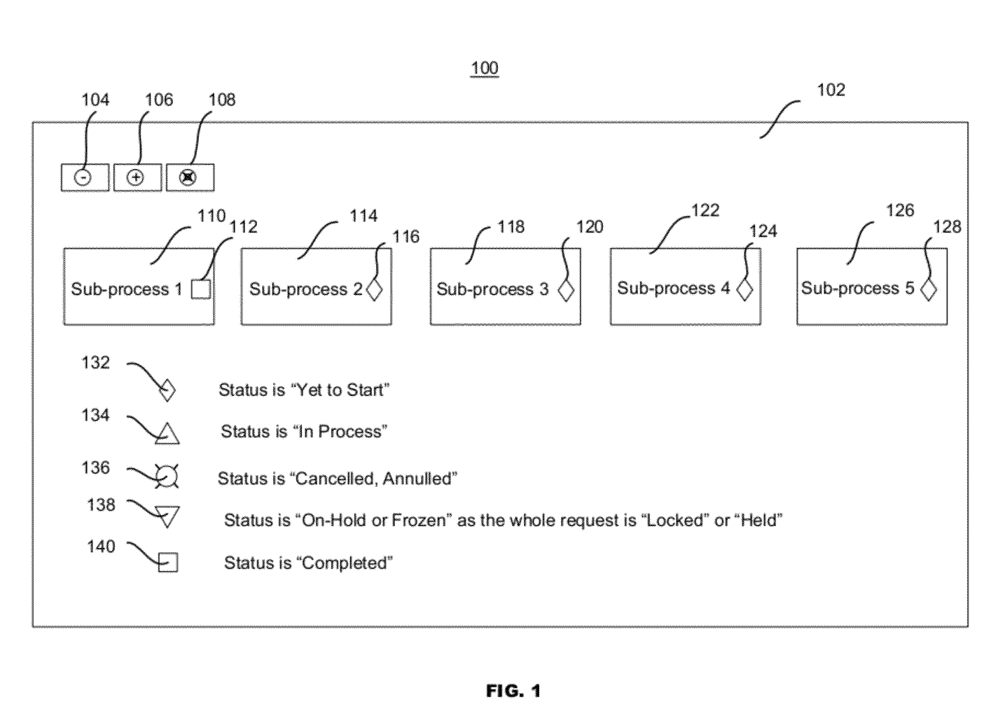

FIG. 1 illustrates an exemplary process overview diagram 100 according to an embodiment. The process overview diagram 100 may comprise a main process 102 represented by a plurality of tabs 110, 114, 118, 122 and 126, and a plurality of view controls 104, 106 and 108. Each tab may be a block or a text box that represents a sub-process of the main process 102. For example, the tab 110 may represent a sub-process 1, the tab 114 may represent a sub-process 2, the tab 118 may represent a sub-process 3, the tab 122 may represent a sub-process 4 and the tab 126 may represent a sub-process 5. Each tab may contain an icon indicating a status of the respective sub-process. The status of the sub-process 1 may be indicated by an icon 112, the status of the sub-process 2 may be indicated by an icon 116, the status of the sub-process 3 may be indicated by an icon 120, the status of the sub-process 4 may be indicated by an icon 124, and the status of the sub-process 5 may be indicated by an icon 128.

The view control 104 may represent a zoom out command to zoom out from a current view, the view control 106 may represent a zoom in command to zoom in from a current view, and the view control 108 may represent a perfect fit command to adjust the view to a be a perfect fit (described in detail below). The main process 102 as shown in FIG. 1 may contain five sub-processes, but in other embodiments, the process overview diagram 100 may also be used for processes with more or less sub-processes. The information about the process and sub-processes (e.g., tasks to be performed, current status) may be stored in a database and updated by the system when a user makes changes (e.g., update contact information, complete a task)

In one embodiment, the icons 112, 116, 120, 124 and 128 may represent the status according to the legends shown in FIG. 1. For example, an icon 132 with a diamond shape may indicate the status is “yet to start,” an icon 134 with an arrow head pointing upwards may indicate the status is “in process,” an icon 136 with a stop light may indicate the status is “canceled or annulled,” an icon 138 with an arrow head pointing downwards may indicate the status is “on-hold” or “frozen” as the sub-process may be locked or held, and an icon 140 with a square shape may indicate the status is “completed.” Accordingly, the status icon 112 of the sub-process 1 may indicate that the sub-process 1 has been completed, the status icons 116, 120, 124 and 128 may indicate the other sub-processes are still in process. It should be noted that the icons are examples and other icons and/or other status information may be used.

In another embodiment, the process overview diagram 100 may further use colors to indicate the status of each sub-process/sub-step. For example, each tab for a sub-process/sub-step may be presented in a pre-determined color that indicates a status. Gray may indicate the status is “yet to start,” yellow may indicate the status is “in process,” red may indicate the status is “canceled or annulled,” blue may indicate the status is “on-hold” or “frozen” as the sub-process/sub-step may be locked or held, and green may indicate the status is “completed.” In some embodiments, the color and icon may be used in combination to indicate the status.

In one embodiment, the sub-processes/sub-step in the main process 102 may be carried out in parallel, that is, a sub-process/sub-step may be started and performed while a previous sub-process/sub-step has not been completed. In another embodiment, the sub-processes/sub-steps in the main process 102 may be carried out in sequence, that is, each sub-process/sub-step may be performed only after the previous sub-process/sub-step is completed. In yet another embodiment, some sub-process or sub-steps may be carried out in parallel and some may be in sequence. For example, sub-process 3 may be performed in parallel with sub-process 4, but sub-process 5 may be started only after all other sub-processes have completed.

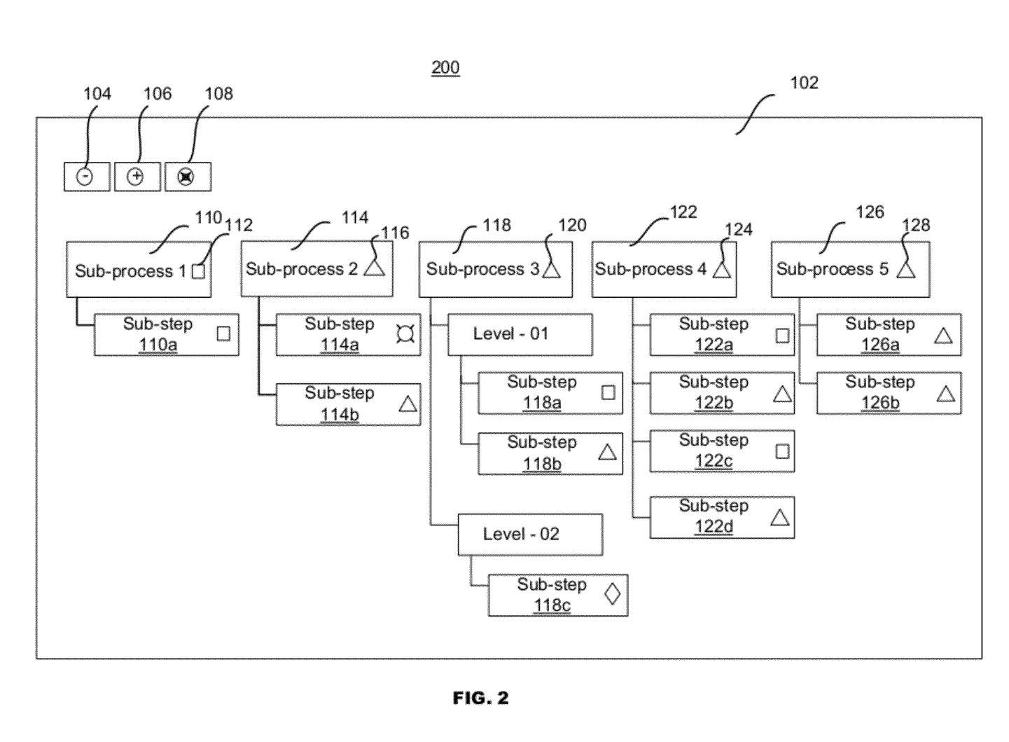

FIG. 2 illustrates an exemplary process overview diagram 200 according to an embodiment. The process overview diagram 200 may present a user interface based on the process overview diagram 100 and like reference numerals may refer to the similar elements. Descriptions of common features are not repeated. The process overview diagram 200 may comprise the tabs representing the sub-processes of the main process 102 as shown in FIG. 1 and further, may comprise tabs (e.g., text boxes) representing sub-steps of each sub-process. As shown in FIG. 2, the sub-process 1 may comprise a sub-step 110a, the sub-process 2 may comprise sub-steps 114a and 114b, the sub-process 4 may comprise sub-steps 122a, 122b, 122c and 122c, and the sub-process 5 may comprise sub-steps 126a and 126b. Tabs representing the sub-steps may be displayed underneath the sub-process belongs and may be linked to the sub-process to show the dependency.

A sub-process may comprise multiple rounds of sub-steps. For example, as shown in FIG. 2, the sub-process 3 may comprise two rounds of sub-steps. In one embodiment, each round may be represented by a level, for example, tabs for level 01 and level 02 as shown underneath the sub-process 3. The level 01 may comprise sub-steps 118a and 118b, and the level 02 may comprise a sub-step 118c. In sub-process 3, the tabs representing sub-steps may be displayed underneath and linked to each round (e.g., level) it belongs.

Each sub-step may comprise an icon indicating the status of the sub-step. The icons and status represented by the icons may be similar to those icons for the sub-processes as described above with respect to FIG. 1. In one embodiment, the status of the sub-process may be determined based on the status of its sub-steps. For example, a sub-process may be “completed” when all sub-steps of the sub-process are “completed” or “cancelled or annulled.” In another example, a sub-process may be “yet to start” when all sub-steps of the sub-process are “yet to start.” In a further example, a sub-process may be in “in process” when at least one of its sub-steps is in one of: “in process” or “on-hold.”

In one embodiment, a sub-step may be identified by a person responsible for the sub-step. For example, the sub-step 114a may be a manager, a human resource specialist, a technical support personnel, etc.

In one embodiment, an automatic popup tip window (e.g., tooltip) may be displayed for a sub-step when a mouse moves over the sub-step. The tip window may display detailed information such as, but not limited to, a person or organization unit in charge, title of the person in charge, description of the what needs to be performed for the sub-step, contact information (e.g., phone number, email address, mailing address), and a picture of the person in charge.

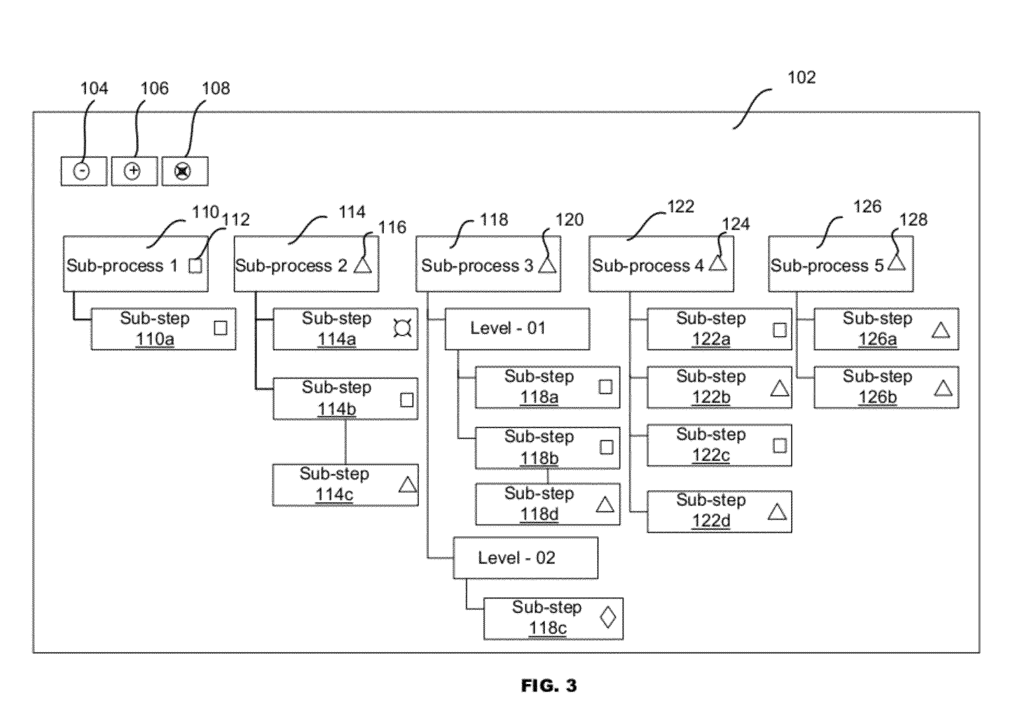

FIG. 3 illustrates another view of an exemplary process overview diagram 300 of the process overview diagram 200 according to an embodiment. The process overview diagram 300 may present a user interface based on the process overview diagram 200, and like reference numerals may refer to the similar elements. Descriptions of the common features are not repeated. The process overview diagram 300 may further comprise a sub-step 114c in addition to all features of FIG. 2. The sub-step 114c may depend from the sub-step 114b, and thus is shown to be linked from the sub-step 114c.

In one embodiment, the sub-step 114c may be a sub-step based on conditions of its parent sub-step 114b. For example, the sub-step 114b may be a task for a human resource specialist to counsel an employee who has submitted a resignation. When the human resource specialist may complete the counseling in the sub-step 114b, a human resource manager may perform the sub-step 114c to check the counseling result.

In another embodiment, the sub-step 114c may be an optional sub-step dynamically added to the whole process based on conditions of its parent sub-step 114b. Using the employee resigning example, the human resource specialist of the sub-step 114b may identify some issues during the counseling and thus, may refer the case to another specialist; or the human resource specialist of the sub-step 114b may be unavailable (e.g., training, vacation, etc.), and the sub-step 114c may be a forwarded counseling task to another human resource specialist. Accordingly, the process overview diagram 300 shows that the process overview diagram 200 may be dynamically expanded by adding new sub-steps when the main process 102 is being carried out.

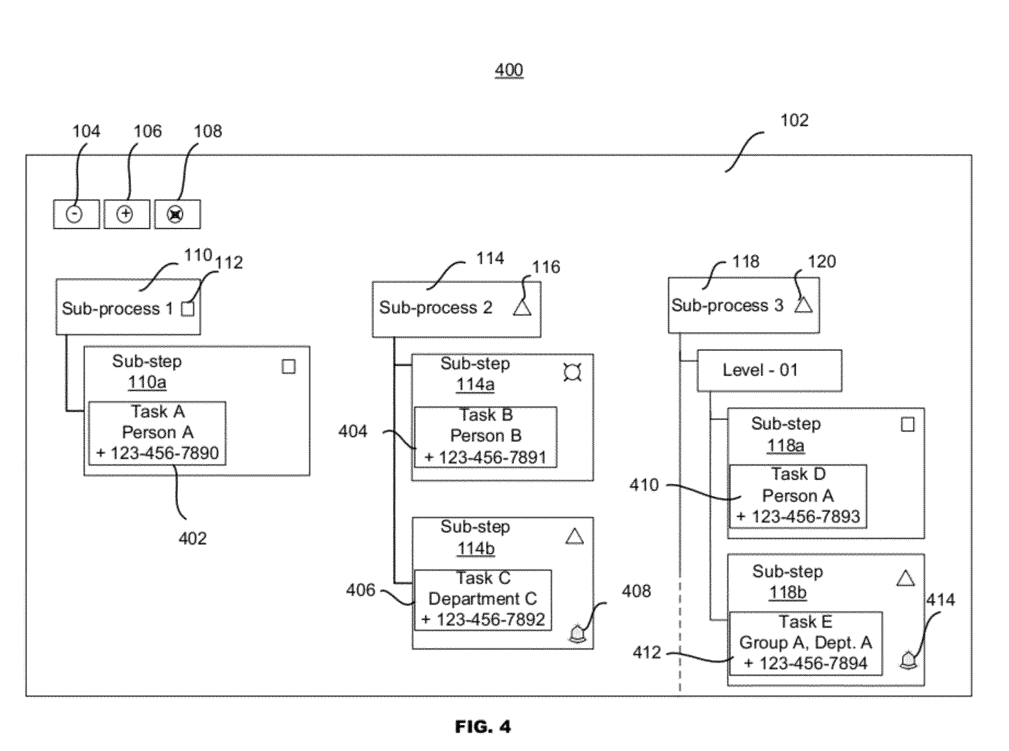

FIG. 4 illustrates a zoomed-in view of an exemplary process overview diagram 400 of a according to an embodiment. The process overview diagram 400 may present a user interface based on the process overview diagram 200 and like reference numerals may refer to the similar elements. Descriptions of the common features are not repeated. As shown in FIG. 4, the process overview diagram 400 may depict a partial view of the process overview diagram 200 in an expanded fashion. In particular, the tab representing the sub-step 110a may comprise a textual label 402, the tab representing the sub-step 114a may comprise a textual label 404 and the tab representing the sub-step 118a may comprise a textual label 410. The tab representing the sub-step 114b may comprise a textual label 406 and a reminder icon 408, and the tab representing the sub-step 118b may comprise a textual label 412 and a reminder icon 414. In one embodiment, the textual labels may comprise further information about each sub-step, for example, a description of the task to be performed, a person or organizational unit in charge of the sub-step, and contact information (e.g., a telephone number) of the person or organizational unit in charge. For sub-steps 114b and 118b with an “in process” status, the reminder icons 408 and 414 may represent a link for sending a reminder (e.g., an email) to the person or organizational unit in charge.

In one embodiment, a sub-step may be identified by the person in charge and accordingly, the detailed view of the process overview diagram 400 may only show the description of the task and the contact number. In another embodiment, the contact number may be replaced with other contact information such as, but not limited to, an email address.

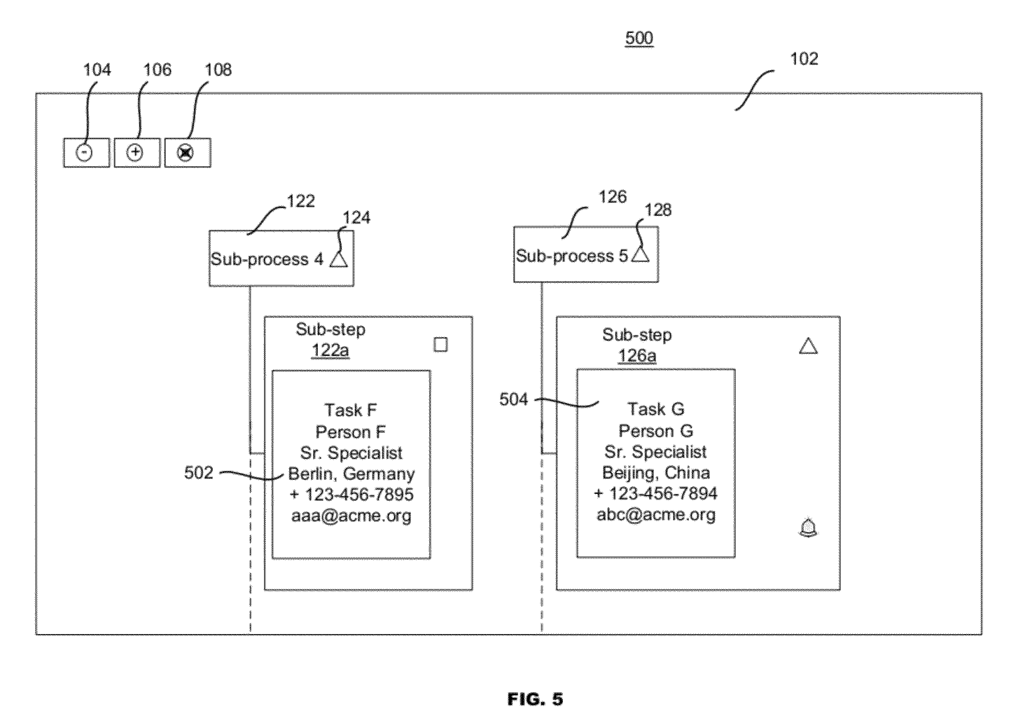

FIG. 5 illustrates a detailed exemplary process overview diagram 500 according to an embodiment. The process overview diagram 500 may present a user interface based on the process overview diagram 200 and like reference numerals may refer to the similar elements. Descriptions of the common features are not repeated. As shown in FIG. 5, the process overview diagram 400 may depict a partial view of the process overview diagram 200 in a further expanded fashion. In particular, the tab representing the sub-step 122a may comprise a textual label 502 and the tab representing the sub-step 126a may comprise a textual label 504. In one embodiment, the textual labels 502 and 504 may comprise further information about the respective sub-steps. For example, in addition to a description of the task to be performed, a person or organizational unit in charge of the sub-step, and contact information of the person or organizational unit in charge as shown in the textual labels of FIG. 4, the textual labels of FIG. 5 may further include the person's title, location, and email address. For sub-step 126a with an “in process” status, a reminder icon similar to the reminder icons 408 and 414 may also be provided.

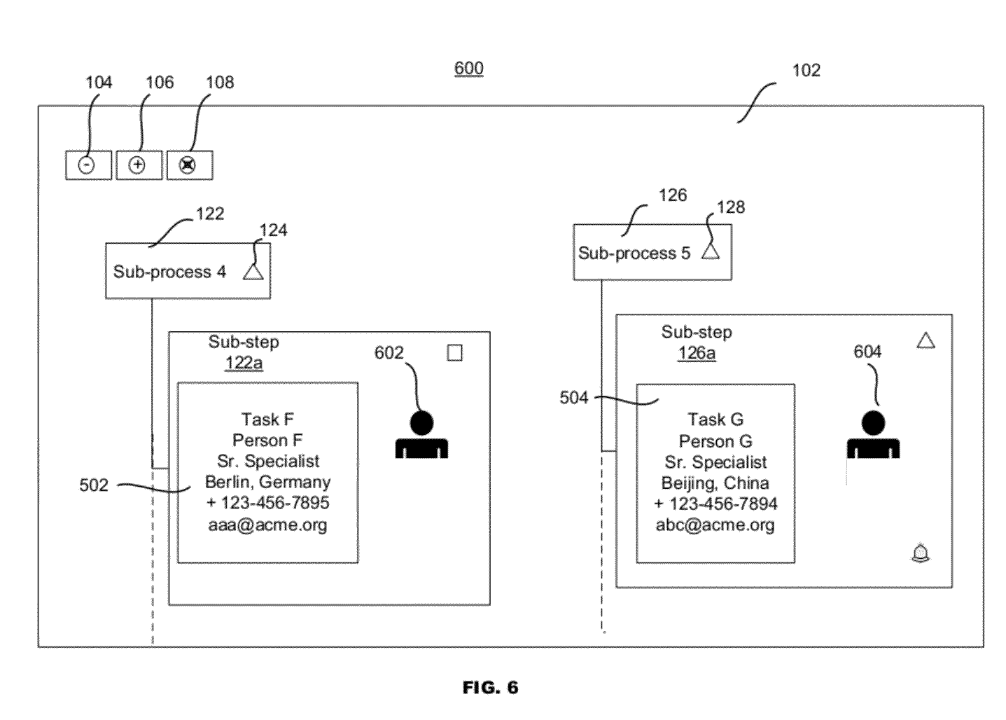

FIG. 6 illustrates a more detailed view of an exemplary process overview diagram 600 according to an embodiment. The process overview diagram 600 may present a user interface based on the process overview diagram 500 and like reference numerals may refer to the similar elements. Descriptions of the common features are not repeated. As shown in FIG. 6, in one embodiment, the more detailed view of a sub-step may comprise a picture of the person in charge. For example, the tab representing the sub-step 122a may comprise a picture 602 of personal F and the tab representing the sub-step 126a may comprise a picture 604 of personal G.

In one or more embodiments, the level of detail shown in the tabs representing sub-steps may be adjusted when a user clicks on one of the view control buttons: the button 104 for zooming out (e.g., less detail), the button 106 for zooming in (e.g., more detail) or the button 108 for a perfect fit. In one embodiment, the perfect fit may be determined based on the display area available for a process overview diagram and number of sub-processes and sub-steps, such that all sub-processes may be shown, and as many as possible of the sub-steps may be shown, though not necessarily in detail.

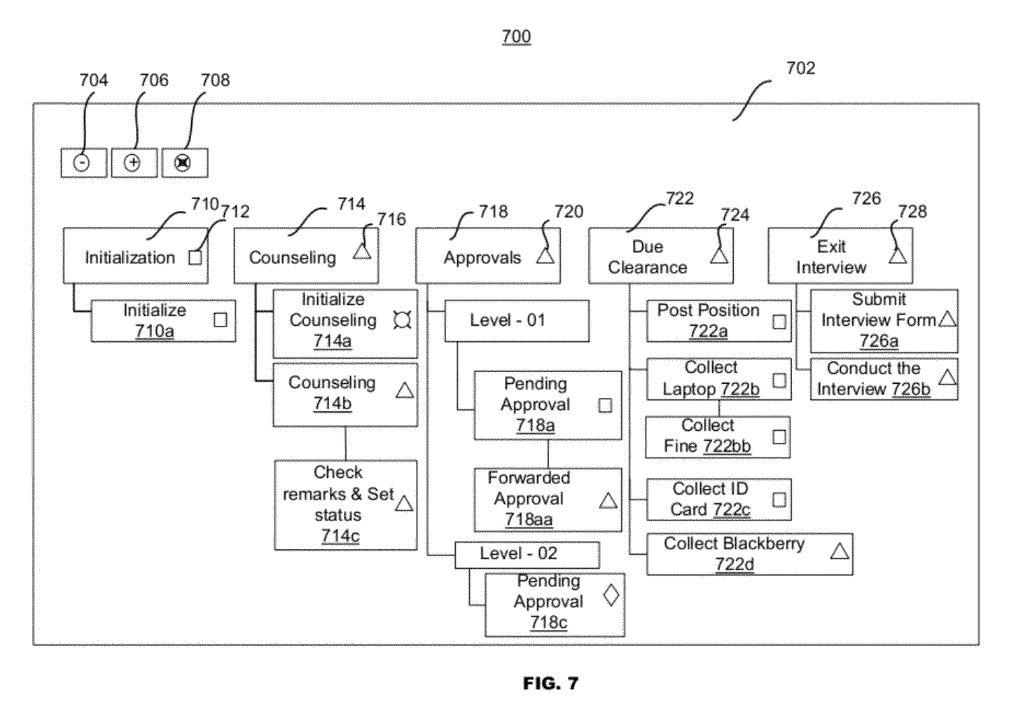

FIG. 7 illustrates an exemplary process overview diagram 700 for an e-separation application according to an exemplary embodiment. The process overview diagram 700 may comprise a view control button 704 for zooming out, a view control button 706 for zooming in and a view control button 708 for a perfect fit view. The e-separation application may provide an end to end process flow 702 for separation of an employee from an employer organization (e.g., when an employee resigns/leaves from an organization). The process flow 702 may comprise five tabs representing an initialization sub-process 710, a counseling sub-process 714, an approvals sub-process 720, a due clearance sub-process 722, and an exit interview sub-process 726, respectively. Each tab may comprise an icon indicating the respective status of each sub-process. The meaning of the icons may be similar to those shown in FIG. 1. For example, the icon 712 may indicate the sub-process initialization 710 has been completed and the icons 716, 720, 724 and 728 may indicate the other sub-processes are still “in process.”

The initialization sub-process 710 may be the first step in the e-separation process and a mandatory step. The initialization sub-process 710 may comprise an initialize sub-step 710a. The tab representing the initialize sub-step 710a may be presented underneath and linked to the tab representing the sub-process 710. The initiation sub-process may be initiated by a resigning employee, a manager or the HR department. In one embodiment, the initialize sub-step 710a may comprise detailed information that may indicate who initiated the whole process 702. Either the employee, manager or a HR person may use a web-browser based portal application to perform the initiate sub-step 710a and any information (e.g., who initiates the process, resignation letter) may be stored in a database. The initialize sub-step 710a may be “in process” until the system updates the master data indicating it has been completed, for example, by writing a pre-separation action to a batch process.

The counseling sub-process 714 may be an optional step in the e-separation process. The counseling sub-process 714 may be performed when the manager/HR decides it may be relevant for the employee and assigns a counselor. The counseling sub-process 714 may comprise one or more rounds of counseling. For each round, the counseling sub-process 714 may comprise several sub-steps. For example, the counseling sub-process 714 may comprise an initialize counseling sub-step 714a that the manager or a HR person may initiate the counseling by assigning a counselor. Then, the counseling sub-process 714 may comprise a counseling sub-step 714b in which the assigned counselor may talk to the employee and update the comments.

In one embodiment, the assigned counselor may cancel the counseling, in which case no further sub-step is needed. If the counselor completes the counseling and updates the comments, then, the counseling sub-process 714 may comprise a sub-step 714c, in which the initiator of the counseling (e.g., manager or HR person) may need to decide whether the counseling was successful and set the status accordingly. If more than one round of counseling is necessary, the sub-steps of counseling the sub-process 714 may be depicted underneath and linked to respective rounds of counseling.

The approvals sub-process 718 may be a mandatory step in the e-separation process The approvals sub-process 718 may be pre-configured, that is, it may be customized to start at a configured time and could have different levels (rounds) happening sequentially. This approvals sub-process 718 may come after a relevant counseling sub-process or directly after the initialization sub-process 710. In any given level (e.g., for two rounds) there could be multiple approvals happening in parallel. As shown in FIG. 7, the approvals sub-process 718 may have two levels (rounds) of approvals: level 01 and level 02. Each level may have one sub-step for each pending approval: pending approvals 718a and 718b. However, the pending approval 718a may be forwarded to a different responsible person (e.g., because of more relevant experience, due to time conflicts), and thus, creating a forwarded approval 718aa. The forwarding may lead to chain of sequence as the forwarded pending approval 718aa may be further forwarded until an approver takes action other than forwarding. In one embodiment, the forwarded approval may be shown underneath and linked to its predecessor sub-step. In one embodiment, different levels of forth coming approvals may be presented even they haven't started.

The due clearance sub-process 724 may be an optional sub-process and may be trigged by customized conditions. For example, the HR department may determine under what conditions a due clearance sub-process may be needed when an employee separates from the organization, and the conditions for triggering the due clearance sub-process may be implemented in the e-separation application. Accordingly, many the due clearance tasks may be system triggered. In some embodiments, however, the manager of the separating employee or an HR specialist may create due clearance tasks during the separating process.

In the embodiment shown in FIG. 7, the due clearance sub-process 724 may comprise one sub-step for each task to be completed, for example, a sub-step for post position 722a, a collect laptop 722b, a collect ID card 722c and a collect blackberry 722d. However, in some situations, one sub-step may lead to another dependent sub-step. For example, the laptop collected may have been damaged by the separating employee and thus, the sub-step 722b may lead to a dependent sub-step of collect fine 722bb.

The exit interview sub-process 726 may be the last step in the process flow 702 of the e-separation application. It may be an optional sub-process and may be trigged by customized conditions. For example, the HR department for an organization may determine under what conditions the exit interview(s) may be needed and the conditions for triggering the exit interview sub-process 726 may be implemented in the e-separation application. Therefore, in some embodiments, the e-separating application may decide whether exit interview and survey are applicable to an employee, and accordingly trigger the exit interview sub-process 726 when necessary. In the embodiment show in FIG. 7, the exit interview sub-process 726 may comprise two sub-steps: submit interview form 726a and conduct interview 726b. For the sub-step of submit interview form 726a, the separating employee may fill and submit the exit interview form; and for the sub-step of conduct interview 726b, an HR person may schedule an exit interview with the employee and complete the submitted exit interview form.

As shown in FIG. 7, the exemplary process overview diagram 700 may depict all sub-processes and sub-steps (e.g., the building blocks) for an e-separation application in an overview presentation such that, a user can clearly identify the current status and the necessary action to be taken by the user. Additionally, detailed information for the responsible person may be provided. In some embodiments, in case the any sub-step is in the status of “in process,” a facility such as the icon 408, 414 (in FIG. 4) may be provided to send a short e-mail reminder.

In one embodiment, in the due clearance sub-process, the focus may be on the task that needs to be completed rather the responsible person who needs to complete the task. Accordingly, the sub-steps may be identified by the tasks need to be completed. In other sub-processes, the task that needs to be done may be understood and thus, the sub-steps may be identified by the responsible person. It should be noted that the e-separation application represented by the process flow 702 may follow public policies or regulations according to the jurisdiction it may be used, and thus, may contain different sub-processes and/or different sub-steps in different countries or regions.

It should be noted that the e-separation application is just one example that can be presented by the process overview diagram according to the present invention. Other processes may be implemented by the process overview diagram as well. For example, a business travel and settlement may also be presented in another embodiment. An exemplary process overview diagram for the business travel and settlement may comprise sub-processes of: request for business travel, approval of travel request, submission of various documents, ticket and accommodation booking, submission of expenses incurred during the travel, approval of the incurred expenses, and settlement of the expenses.

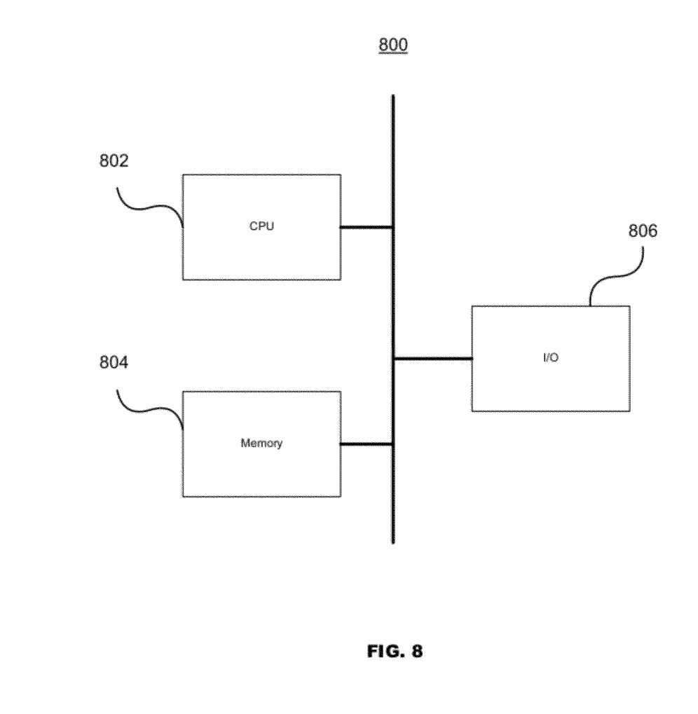

FIG. 8 depicts a structure of a computer 800 according to one embodiment of the invention. The computer 800 includes a processor 802, memory 804, and an I/O device(s) 806. The processor 802 is connected to the memory 804 and I/O device(s) 806. These connections are direct or via other internal electronic circuitry or components.

The processor 802 is a programmable processor that executes instructions residing in the memory 804 to receive and send data via the I/O device(s) 806. The instructions may perform the operations of an exemplary system providing the process overview diagram described herein. The term programmable processor as used herein is any programmable microprocessor or processor or combination of microprocessors or processors that can operate on digital data, which may be special or general purpose processors coupled to receive data and instructions from, and to transmit data and instructions to, a machine-readable medium. According to one embodiment of the present invention processor 802 is an Intel microprocessor.

Memory 804 is a machine-readable medium that stores data that is processed by processor 802. The term machine-readable medium as used herein is any addressable storage device that stores digital data including any computer program product, apparatus and/or device (e.g., a random access memory (RAM), read only memory (ROM), magnetic disc, optical disc, programmable logic device (PLD), tape, hard drives, RAID storage device, flash memory or any combination of these devices). This may include external machine-readable mediums that are connected to processor 802 via one or more I/O device(s) 806.

The I/O device(s) 806 may be one or more input/output interfaces that receive and/or send digital data to and from an external device. Interfaces as used herein are any point of access to an external device where digital data is received or sent, including ports, buffers, queues, subsets thereof, or any other interface to an external device.

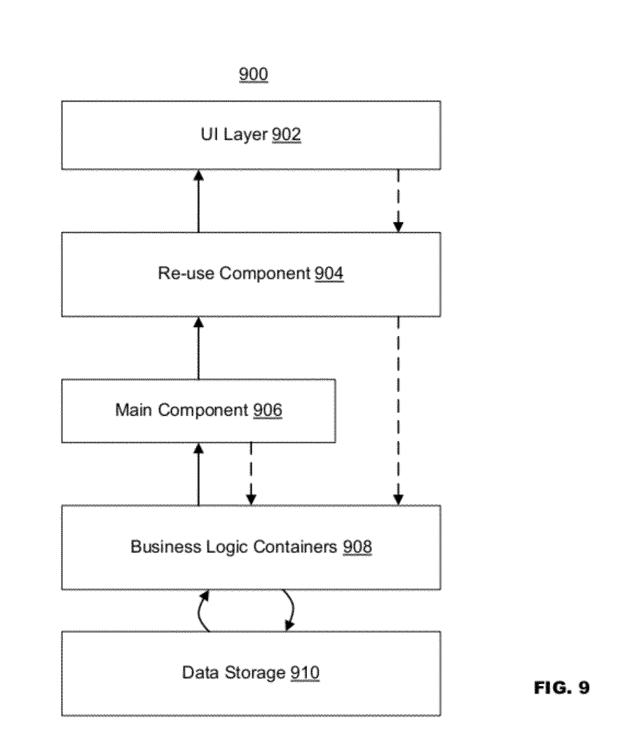

FIG. 9 depicts a block diagram of an exemplary system 900 according to one embodiment of the invention. The exemplary system 900 may comprise a UI Layer 902, a re-use component 904 and a main component 906, a business logic containers 908 and a data storage 910. The UI layer 902 may display a process overview diagram (e.g., the process overview diagram 700). In one embodiment, the UI layer 902 may display the 2-dimensional view of the processes and their sub-steps in flash island(s) (e.g., a flash embedded in a web page). The flash island(s) may include controls to zoom-in, zoom-out and display a perfect fit of the 2-dimensional view. Further, the flash island(s) may include reminder links (e.g., icons representing links/buttons) for “in process” tasks.

In some embodiments, the flash island(s) may be embedded on web pages such that the actions for zoom-in, zoom-out, perfect fit may be implemented as client side action(s) without communication to a server. However, sending a reminder may still need to communicate with server side modules, such as email servers or adapter of email servers.

The re-use component 904 may hold the UI layer 902, and generate a process overview diagram to be displayed on the UI layer 902 when triggered by the main component 906. In one embodiment, the re-use component 904 may perform the following actions: to convert the business data received from the main component 906 to a predetermined format (e.g., XML File) for the UI layer 902; and to call a relevant data object (e.g., a class implemented in an object oriented programming language) to send the email when the reminder link may be invoked.

The main component 906 may be the central component of the exemplary system 900. In one embodiment, upon receipt of a request to generate a process overview diagram, the main component 906 may trigger the “process overview” functionality of the re-use component 904, get all the information (different sub-processes and their sub-steps) related to the request from the business logic containers 908, and pass the retrieved information to the re-use component 904.

The business logic containers 908 may be a business logic layer provided between the main component 906 and the data storage 910. The business logic containers 908 may include a plurality of data objects accessing the data stored in the data storage 910 and implementing business logics.

The data storage 910 may store relevant information about the business process(es). For example, the data storage 910 may store information for the e-separation application, such as, information for all sub-processes and sub-steps.

In one embodiment, the exemplary system may be implemented as a web portal application. The UI layer 902 may be implemented as web pages to be downloaded to web browsers, the re-use component 904 and the main component 906 may be server side logic to render the web pages, and the business logic containers 908 may implement the business logic and provide the data access to the data storage 910.

The exemplary method and computer program instructions may be embodied on a machine readable storage medium such as a computer disc, optically-readable media, magnetic media, hard drives, RAID storage device, and flash memory. In addition, a server or database server may include machine readable media configured to store machine executable program instructions. The features of the embodiments of the present invention may be implemented in hardware, software, firmware, or a combination thereof and utilized in systems, subsystems, components or subcomponents thereof. When implemented in software, the elements of the invention are programs or the code segments used to perform the necessary tasks. The program or code segments can be stored on machine readable storage media. The “machine readable storage media” may include any medium that can store information. Examples of a machine readable storage medium include electronic circuits, semiconductor memory device, ROM, flash memory, erasable ROM (EROM), floppy diskette, CD-ROM, optical disk, hard disk, fiber optic medium, or any electromagnetic or optical storage device. The code segments may be downloaded via computer networks such as Internet, Intranet, etc.

Although the invention has been described above with reference to specific embodiments, the invention is not limited to the above embodiments and the specific configurations shown in the drawings. For example, some components shown may be combined with each other as one embodiment, or a component may be divided into several subcomponents, or any other known or available component may be added. The operation processes are also not limited to those shown in the examples. Those skilled in the art will appreciate that the invention may be implemented in other ways without departing from the sprit and substantive features of the invention. For example, features and embodiments described above may be combined with and without each other. The present embodiments are therefore to be considered in all respects as illustrative and not restrictive. The scope of the invention is indicated by the appended claims rather than by the foregoing description, and all changes that come within the meaning and range of equivalency of the claims are therefore intended to be embraced therein.

What is claimed is:

1. A system for process management, comprising:
a memory to store computer program instructions; and
a processor configured to execute the computer program instructions to:
read information about sub-processes of a main process, the information including sub-steps for each sub-process;
display a process overview diagram for the main process, the process overview diagram including a tab for each sub-process and sub-step respectively, the tab for each sub-step being displayed underneath the respective sub-process and linked to the respective sub-process, each tab including an icon indicating the status of the respective sub-process or sub-step;
responsive to a click to select a view level, expand the tabs for sub-steps to show a person responsible for the respective sub-step, the extended tabs also providing detailed contact information of the responsible person, a description of what the responsible person needs to do and a link to send a quick reminder to the responsible person when the status for the respective sub-step is “in process”.

2. The system of claim 1, wherein the detailed contact information includes a telephone number and an email address, and the tabs for sub-steps further include pictures and location of the responsible persons respectively.

3. The system of claim 1, wherein each tab also shows a predetermined color indicating the status.

4. The system of claim 1, wherein the icon displayed on each tab is one of: a diamond to indicate the status is yet to start, an arrow pointing upwards to indicate the status is in process, a stop light to indicate the status is canceled or annulled, an arrow pointing downwards to indicate the status is on-hold or frozen, and a square to indicate the status is completed.

5. The system of claim 1, wherein process overview diagram includes action buttons to choose a perfect fit, zoom in and zoom out.

6. The system of claim 1, wherein the main process is an employee separation process, and the sub-processes include initialization, counseling, approvals, due clearance and exit interview.

7. The system of claim 1, wherein at least one of the sub-step leads to a dependent sub-step.

8. A non-transitory computer-readable storage medium embodied with program instructions for causing a computer to execute a method for cross process integration (PI) component monitoring, the method comprising:
reading information about sub-processes of a main process, the information including sub-steps for each sub-process;
displaying a process overview diagram for the main process, the process overview diagram including a tab for each sub-process and sub-step respectively, the tab for each sub-step being displayed underneath the respective sub-process and linked to the respective sub-process, each tab including an icon indicating the status of the respective sub-process or sub-step;
responsive to a click to select a view level, expanding the tabs for sub-steps to show a person responsible for the respective sub-step, the extended tabs also providing detailed contact information of the responsible person, a description of what the responsible person needs to do and a link to send a quick reminder to the responsible person when the status for the respective sub-step is “in process”.

9. The non-transitory computer-readable storage medium of claim 8, wherein the detailed contact information includes a telephone number and an email address, and the tabs for sub-steps further include pictures and location of the responsible persons respectively.

10. The non-transitory computer-readable storage medium of claim 8, wherein each tab also shows a predetermined color indicating the status.

11. The non-transitory computer-readable storage medium of claim 8, wherein the icon displayed on each tab is one of: a diamond to indicate the status is yet to start, an arrow pointing upwards to indicate the status is in process, a stop light to indicate the status is canceled or annulled, an arrow pointing downwards to indicate the status is on-hold or frozen, and a square to indicate the status is completed.

12. The non-transitory computer-readable storage medium of claim 8, wherein process overview diagram includes action buttons to choose a perfect fit, zoom in and zoom out.

13. The non-transitory computer-readable storage medium of claim 8, wherein the main process is an employee separation process, and the sub-processes include initialization, counseling, approvals, due clearance and exit interview.

14. The non-transitory computer-readable storage medium of claim 8, wherein at least one of the sub-step leads to a dependent sub-step.

15. A computer implemented method, the method comprising:
reading information about sub-processes of a main process, the information including sub-steps for each sub-process;
displaying a process overview diagram for the main process, the process overview diagram including a tab for each sub-process and sub-step respectively, the tab for each sub-step being displayed underneath the respective sub-process and linked to the respective sub-process, each tab including an icon indicating the status of the respective sub-process or sub-step;
responsive to a click to select a view level, expanding the tabs for sub-steps to show a person responsible for the respective sub-step, the extended tabs also providing detailed contact information of the responsible person, a description of what the responsible person needs to do and a link to send a quick reminder to the responsible person when the status for the respective sub-step is “in process”.

16. The computer implemented method of claim 15, wherein the detailed contact information includes a telephone number and an email address, and the tabs for sub-steps further include pictures and location of the responsible persons respectively.

17. The computer implemented method of claim 15, wherein each tab also shows a predetermined color indicating the status.

18. The computer implemented method of claim 15, wherein the icon displayed on each tab is one of: a diamond to indicate the status is yet to start, an arrow pointing upwards to indicate the status is in process, a stop light to indicate the status is canceled or annulled, an arrow pointing downwards to indicate the status is on-hold or frozen, and a square to indicate the status is completed.

19. The computer implemented method of claim 15, wherein process overview diagram includes action buttons to choose a perfect fit, zoom in and zoom out.

20. The computer implemented method of claim 15, wherein the main process is an employee separation process, and the sub-processes include initialization, counseling, approvals, due clearance and exit interview.

21. The computer implemented method of claim 15, wherein at least one of the sub-step leads to a dependent sub-step.
